(19) United States
(12) Patent Application Publication
(10) Pub. No.: US 2017/0226895 A1
(43) Pub. Date: Aug. 10, 2017

(54) EXHAUST TURBOCHARGER, AND METHOD OF MAKING SUCH AN EXHAUST TURBOCHARGER

(71) Applicant: AUDI AG, lngolstadt (DE)

(72) Inventors: MAXIMILIAN KÖHNLEIN, lngolstadt (DE); FLORIAN EDMÜLLER, Langenbruck (DE)

(73) Assignee: AUDI AG, lngolstadt (DE)

(21) Appl. No.: 15/428,487

(22) Filed: Feb. 9, 2017

(30) Foreign Application Priority Data
Feb. 10, 2016 (DE) 102016001496.2

(51) Int. Cl. F01D 25/24; F01D 11/00; F01D 25/16

(52) U.S. Cl. CPC F01D 25/243; F01D 25/162; F01D 11/003; F05D 2220/40

(57) ABSTRACT

An exhaust turbocharger includes a turbine housing having a flange rim, and a bearing housing having a flange rim. Arranged between the flange rim of the turbine housing and the flange rim of the bearing housing is a ring which is made of sheet metal. The flange rim of the turbine housing and the flange rim of the bearing housing are connected to one another to form a flange.

### CROSS-REFERENCES TO RELATED APPLICATIONS

This application claims the priority of German Patent Application, Serial No. 10 2016 001 496.2, filed Feb. 10, 2016, pursuant to 35 U.S.C. 119(a)-(d), the disclosure of which is incorporated herein by reference in its entirety as if fully set forth herein.

### BACKGROUND OF THE INVENTION

The present invention relates to an exhaust turbocharger and to a method of making such an exhaust turbocharger.

The following discussion of related art is provided to assist the reader in understanding the advantages of the invention, and is not to be construed as an admission that this related art is prior art to this invention.

U.S. Pat. No. 8,827,638 discloses an exhaust turbocharger having a turbine housing and a bearing housing which are centered relative to each other and connected to each other in the region of a connection joint including a sealing assembly with a heat shield disposed between the turbine housing and the bearing housing. At least one cutout is provided in the heat shield for accommodating a centering means by way of which the turbine housing and the bearing housing are directly centered relative to one another.

It would be desirable and advantageous to provide an improved exhaust turbocharger and an improved method of making such an exhaust turbocharger to obviate prior art shortcomings.

### SUMMARY OF THE INVENTION

According to one aspect of the present invention, an exhaust turbocharger includes a turbine housing having a flange rim, a bearing housing having a flange rim, and a ring made of sheet metal and arranged between the flange rim of the turbine housing and the flange rim of the bearing housing, wherein the flange rim of the turbine housing and the flange rim of the bearing housing are connected to one another to form a flange.

In accordance with the present invention, a ring of sheet metal and thus a metallic ring is arranged between the flange rims of the turbine housing and bearing housing. The ring may, optionally, be coated.

According to another advantageous feature of the present invention, a clip can be provided to embrace the flange rims of the turbine housing and the bearing housing to thereby connect the turbine housing and of the bearing housing to one another.

According to another advantageous feature of the present invention, the ring can be configured to provide a secondary frictional seal.

According to another advantageous feature of the present invention, at least one of the flange rim of the turbine housing and the flange rim of the bearing housing can have a groove for receiving the ring, at least in part. Advantageously, the groove is defined by a depth which is less than an axial height of the ring. For example, the depth of the groove can be less than a cross sectional area of the ring. The cross sectional area of the ring can hereby be defined by an inner radius, outer radius and the axial height of the ring.

According to another aspect of the present invention, a method for making an exhaust turbocharger includes placing or clamping a ring of sheet metal between a flange rim of a turbine housing and a flange rim of a bearing housing, and connecting the flange rim of the turbine housing and the flange rim of the bearing housing to one another to form a flange.

According to another advantageous feature of the present invention, a tightness of the flange between the turbine housing and the bearing housing can be tested at a temperature which is less than a limit value. The maximum temperature at which the test is executed is 200° C. The tightness of the flange is, advantageously, tested, when the exhaust turbocharger is connected to a combustion engine.

The provision of the ring in a region of the flange, via which the turbine housing and the bearing housing are connected to one another, enables implementation of a cold test to test the exhaust turbocharger. For this purpose, the ring is placed into the region of the flange formed between the flange rims of the turbine housing and the bearing housing. The presence of this ring ensures air tightness of the flange under the constraints of a cold test for the exhaust turbocharger, with the ring establishing a seal between the flange rims of the turbine and bearing housings in the secondary frictional connection. The ring does hereby not necessarily need to provide a sealing effect during normal operation of the exhaust turbocharger, i.e. in the presence of high temperatures.

When producing and assembling the exhaust turbocharger, the ring is placed upon a flange rim of one of the turbine and bearing housings and is maintained under tension between the turbine and bearing housings to be joined. The ring is configured such that a required axial biasing force is slightly increased since the ring normally needs to provide a sealing effect only in the cold state. There is therefore no need for providing a greater clip or greater V-band clip. In addition, the ring can be made of a material that is appropriate for low temperatures, so that the ring does not have to be dimensioned to withstand high temperatures.

After installing the assembled exhaust turbocharger in a combustion engine, a cold test is carried out. Provision is hereby made for the ring to ensure air tightness of the flange in the region of the flange at an excess pressure of 0.30 bar. Since no combustion takes place in the combustion engine during the cold start, it is not necessary to dimension the ring for exposure to high temperatures. For example, the ring does not need to provide a sealing effect, when the temperature exceeds 200° C. Still, it is within the scope of the present invention, to also configure the ring to provide a sealing effect at temperatures exceeding 200° C.

The ring can be made of a metallic material that is adequate to meet the demands at hand, and thus may vary depending on the application. The material is hereby typically selected in dependence on the requirements for a tightness of the ring according to parameters of the cold test.

In terms of stress on the ring during the cold test, the material for the ring can be selected according to EN ISO 16120-26 standard (2016). At least one material for the ring is chosen according to grades SL (low tensile strength), SM (medium tensile strength) and SH (high tensile strength) in accordance with EN ISO standard 161.20-26. This material is appropriate for static stress during cold test. In addition, at least a material for the ring should be selected that is appropriate for stress in a dynamic load.

The ring between the turbine housing and the bearing housing can be shaped as a function of an interface between the turbine housing and the bearing housing, e.g. as a function of a shape of the groove, with the shape and dimension of the ring being chosen in accordance with functional requirements with respect to tightness in the cold test. Tightness may also be ensured in the presence of higher temperatures.

In general, any material can be used so long as functional requirements in terms of tightness in the cold test are met, i.e. the ring may be made of materials other than those listed in EN ISO 16120-2.

The ring may be provided with a coating. Also, the ring can be configured in accordance with DIN 6796 standard (2016). In this case, the ring is configured as tension disk and/or disc spring.

A spring biasing force and characteristic curve of the ring can be selected and/or varied in dependence on the definition of the interface between the turbine and bearing housings.

The ring provided for the exhaust turbocharger to seal the flange supplements a clip or V-band clip by which the turbine housing and the bearing housing are connected to one another in the region of the flange. The flange can further be realized by axially compressing the metallic flange rims of the turbine and bearing housings as contact partners. In a temperature range of about −40° C. up to significantly more than 1000° C., at which the exhaust turbocharger operates, air tightness can thus be ensured. Normally, the ring can find application in different flanges or flange connections, e.g. in a connection realized by a screw flange.

In the cold test, typically carried out in a factory in which a combustion engine and/or an exhaust system, including an exhaust turbocharger, are manufactured, basic functions and basic properties of the exhaust turbocharger are tested. Also tested is hereby the oil chamber of the combustion engine. For this purpose, the oil chamber of the combustion engine is subjected to a pressure, at which a predefined leakage amount of oil should not be exceeded. The use of the ring prevents the presence of otherwise encountered high leakage rates in the region of the flange between the turbine housing and the bearing housing. Thus, it is possible, to test in the cold test the entire combustion engine and/or the entire exhaust system, including exhaust turbocharger.

The ring provided for the flange can be arranged as separate secondary frictional seal between the flange rims so as to establish a sealing effect during the cold state of the exhaust turbocharger. It is hereby possible to arrange the ring also in a groove of the flange rim of the turbine housing or the bearing housing.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic sectional detailed view of an exhaust turbocharger according to the present invention; and

FIG. 2 is an enlarged sectional view of an area marked by dashdotted line II in FIG. 1.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

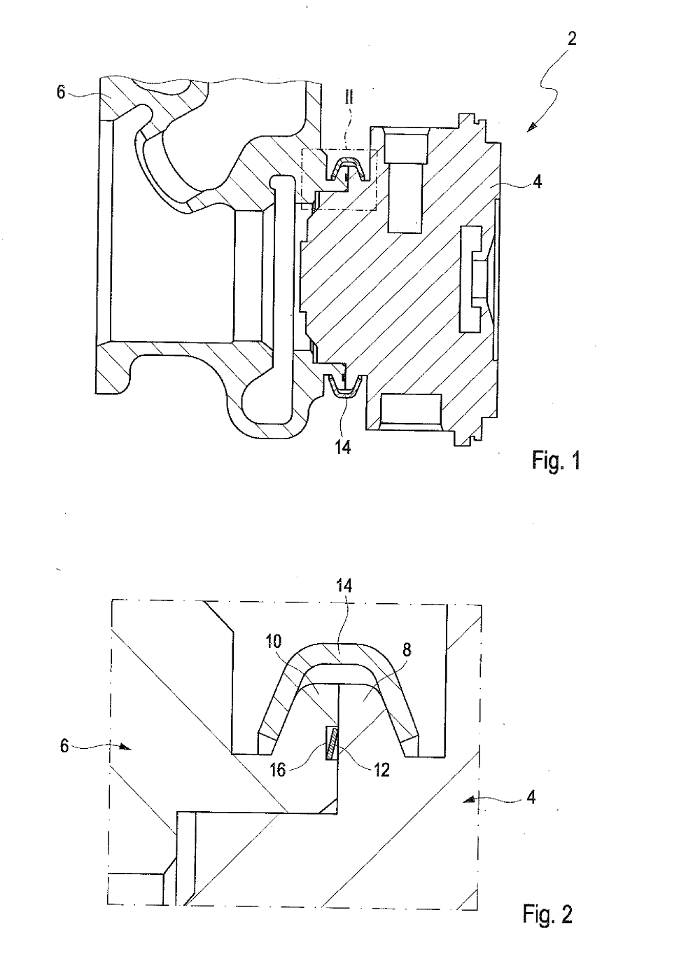

Turning now to the drawing, and in particular to FIG. 1, there is shown a schematic sectional detailed view of an exhaust turbocharger according to the present invention, generally designated by reference numeral 2. The exhaust turbocharger 2 includes a bearing housing 4 and a turbine housing 6. A flange rim 8 of the bearing housing 4 and a flange rim 10 of the turbine housing 6 are arranged axially next to one another, as shown in greater detail in FIG. 2, which is an enlarged sectional view of an area marked by dashdotted line II in FIG. 1.

A ring 12 made of sheet metal is arranged between the flange rims 8, 10 within a groove 16 in the flange rim 10 of the turbine housing 6. Both flange rims 8, 10 are further connected to each other by a V-shaped clip 14 which embraces the flange rims 8, 10 to thereby form a flange. The groove 16 is defined by a depth which is less than an axial height of the ring 12. The provision of the ring 12 in a region of the flange, via which the turbine housing 6 and the bearing housing 4 are connected to one another, enables implementation of a cold test to test the exhaust turbocharger 2. For this purpose, the ring 12 is placed in the groove 16 in the region of the flange formed between the flange rims 8, 10 of the turbine housing 6 and the bearing housing 4 and establishes a separate secondary frictional seal between the flange rims 8, 10 to ensure air tightness of the flange, when the cold test is carried out.

The ring 12 can be made of sheet metal or any metallic material that is adequate to meet the demands at hand, and thus may vary depending on the application. The material is hereby typically selected in dependence on the requirements for a tightness of the ring 12 according to parameters of the cold test. Examples of a material include those according to EN ISO 16120-26 standard (2016). In general, any material can be used so long as functional requirements in terms of tightness in the cold test are met, i.e. the ring may be made of materials other than those listed in EN ISO 16120-2, e.g. in accordance with DIN 6796 standard (2016). Although not shown in greater detail, the ring 12 can be provided with a coating.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An exhaust turbocharger, comprising:
a turbine housing having a flange rim;
a bearing housing having a flange rim; and
a ring made of sheet metal and arranged between the flange rim of the turbine housing and the flange rim of the bearing housing,
wherein the flange rim of the turbine housing and the flange rim of the bearing housing are connected to one another to form a flange.

2. The exhaust turbocharger of claim 1, further comprising a clip configured to embrace the flange rims of the turbine housing and the bearing housing to thereby connect the turbine housing and of the bearing housing to one another.

3. The exhaust turbocharger of claim 1, wherein the ring is configured to provide a secondary frictional seal.

4. The exhaust turbocharger of claim 1, wherein at least one of the flange rim of the turbine housing and the flange rim of the bearing housing has a groove for receiving the ring.

5. The exhaust turbocharger of claim 4, wherein the groove is defined by a depth which is less than an axial height of the ring.

6. A method for making an exhaust turbocharger, comprising:
placing a ring of sheet metal between a flange rim of a turbine housing and a flange rim of a bearing housing; and
connecting the flange rim of the turbine housing and the flange rim of the bearing housing to one another to form a flange.

7. The method of claim 6, further comprising testing a tightness of the flange between the turbine housing and the bearing housing at a temperature which is less than a limit value.

8. The method of claim 7, wherein the temperature is at most 200° C.

9. The method of claim 6, further comprising testing a tightness of the flange, when connecting the exhaust turbocharger to a combustion engine.

10. The method of claim 6, further comprising embracing the flange rims of the turbine housing and the bearing housing by a clip to thereby connect the turbine housing and of the bearing housing to one another.

11. The method of claim 6, further comprising placing the ring in a groove of at least one of the flange rims of the turbine and bearing housings.
